(19) United States
(12) Patent Application Publication
(10) Pub. No.: US 2019/0394342 A1
(43) Pub. Date: Dec. 26, 2019

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Kaori SHIBUYA, Kanagawa (JP)

(73) Assignee: FUJI XEROX CO., LTD., Tokyo (JP)

(21) Appl. No.: 16/438,496

(22) Filed: Jun. 12, 2019

(30) Foreign Application Priority Data
Jun. 20, 2018 (JP) 2018-117122

(51) Int. Cl. H04N 1/00; G06F 16/21; H04N 1/23

(52) U.S. Cl. CPC H04N 1/0097; H04N 1/2315; G06F 16/219; H04N 1/00477

(57) ABSTRACT

An information processing apparatus includes a presentation section that, in a case where cancellation of a movement operation with respect to an object is received and another operation which is executed after the movement operation corresponding to a cancellation target exists, presents a screen used to receive treatment of the other operation.

### CROSS-REFERENCE TO RELATED APPLICATIONS

This application is based on and claims priority under 35 USC 119 from Japanese Patent Application No. 2018-117122 filed Jun. 20, 2018.

### BACKGROUND

### (i) Technical Field

The present invention relates to an information processing apparatus and a non-transitory computer readable medium storing a program.

### (ii) Related Art

There is a technology for enabling a cancelled operation to be redone (performed again) by preparing a first database (editing database or a common operation history database) which preserves a history of an operation and a second database (cancelled operation database) which preserves a history of an operation which is cancelled from the first database.

### SUMMARY

In a case where a movement operation is cancelled in a technology for preparing a database which preserves a history of an operation and a database which preserves a history of a cancelled operation, content of editing, which is performed after the movement operation, is also cancelled.

Aspects of non-limiting embodiments of the present disclosure relate to an information processing apparatus and a non-transitory computer readable medium storing a program, which improve efficiency of a job, compared to a case where, in the case where the movement operation is cancelled, another operation, which is executed after the movement operation, is also cancelled.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a presentation section that, in a case where cancellation of a movement operation with respect to an object is received and another operation which is executed after the movement operation corresponding to a cancellation target exists, presents a screen used to receive treatment of the other operation.

### BRIEF DESCRIPTION OF THE DRAWINGS

Exemplary embodiment(s) of the present invention will be described in detail based on the following figures, wherein:

FIG. 1 is a diagram illustrating an example of a configuration of a work management system according to a first exemplary embodiment;

FIG. 2 is a diagram illustrating an example of a configuration of hardware of an operation history management server according to the first exemplary embodiment;

FIG. 3 is a diagram illustrating an example of a functional configuration of the operation history management server according to the first exemplary embodiment;

FIGS. 4A to 4C are diagrams illustrating a movement operation, which is a cancellation target, and another subsequent operation, FIG. 4A illustrates a location of a data file acquired before the movement operation, FIG. 4B illustrates a location of the data file acquired after the movement operation, and FIG. 4C illustrates a state in which editing is added to the data file acquired after the movement operation;

FIGS. 5A to 50 are diagrams illustrating examples of operation screens prepared for a basic specification. FIG. 5A illustrates an example of an operation screen used to display a history of an operation, FIG. 5B illustrates an example of an operation screen used to display options with respect to the movement operation, and FIG. 5C illustrates an example of an operation screen used to display options in a case where the operation is cancelled;

FIG. 6 is a flowchart illustrating an example of a processing operation in a case where an operation executed after the movement is cancelled;

FIGS. 7A to 7C are diagrams illustrating examples of the operation screens prepared for the basic specification. FIG. 7A illustrates a state in which the movement operation is selected on the operation screen, FIG. 7B illustrates a state in which cancellation of the operation is selected on the operation screen, and FIG. 7C illustrates a state in which a button “cancel operation executed after movement” is selected on the operation screen;

FIGS. 8A to 8C are diagrams illustrating locations and states of the basic specification acquired before and after the movement operation is cancelled, FIG. 8A illustrates a display state acquired before the movement operation is cancelled, FIG. 8B illustrates a transitional state (not illustrated in the drawing) while the movement operation is cancelled, and FIG. 8C illustrates a display state acquired after the movement operation is cancelled;

FIG. 9 is a flowchart illustrating an example of a processing operation in a case where the operation executed after the movement is left;

FIGS. 10A to 10C are diagrams illustrating examples of the operation screens prepared for the basic specification, FIG. 10A illustrates a state in which the movement operation is selected on the operation screen, FIG. 10B illustrates a state in which the cancellation of the operation is selected on the operation screen, and FIG. 10C illustrates a state in which a button “leave operation executed after movement” is selected on the operation screen;

FIG. 11 is a diagram illustrating a state of the basic specification acquired before the movement operation is cancelled;

FIG. 12 is a diagram illustrating a first transitional state acquired while the movement operation is cancelled;

FIG. 13 is a diagram illustrating a second transitional state acquired while the movement operation is cancelled;

FIG. 14 is a diagram illustrating a state of the basic specification acquired after the movement operation is cancelled;

FIG. 15 is a flowchart illustrating an example of the processing operation in case where a history of the movement operation is replaced by a copy operation while leaving the operation executed after the movement;

FIGS. 16A to 16C are diagrams illustrating examples of the operation screens prepared for the basic specification, FIG. 16A illustrates a state in which the movement operation is selected on the operation screen, FIG. 16B illustrates a state in which the cancellation of the operation is selected on the operation screen, and FIG. 16C illustrates a state in which a button “change to copy operation” is selected on the operation screen;

FIG. 17 is a diagram illustrating an example of the state of the basic specification acquired after the movement operation is cancelled;

FIGS. 18A to 18C are diagrams illustrating the cancellation of an operation of moving a location on a display, FIG. 18A illustrates an example of an image in which figures are disposed, FIG. 18B illustrates an example of an operation history screen displayed in a case where a cancellation button is operated, and FIG. 18C illustrates an example of an operation screen used to display options in a case where the operation is cancelled;

FIG. 19 is a diagram illustrating change in a display corresponding to an operation which appears on the image, (A) of FIG. 19 illustrates a disposition acquired before an object is moved, (B) of FIG. 19 illustrates a disposition acquired after the object is moved, (C) of FIG. 19 illustrates a state acquired after a size of the object is changed, and (D) of FIG. 19 illustrates a state in which the filling effect is added to the object;

FIGS. 20A to 20D are diagrams illustrating examples of an image in which the operation executed after the object is moved is left and an image in which the operation executed after the object is moved is removed, FIGS. 20A and 20B illustrate examples of the operation history screen corresponding to the image in which the operation executed after the object is moved is left, and FIGS. 20C and 20D illustrate examples of the operation history screen corresponding to the image in which the operation executed after the object is moved is removed;

FIGS. 21A and 21B are diagrams illustrating examples of another image in a case where the operation executed after the object is moved is left, FIG. 21A illustrates an example of the image in the case where the operation executed after the object is moved is left, and FIG. 21B illustrates an example of the relevant operation history screen; and

FIG. 22A and 22B are diagrams illustrating examples of another image in a case where an object movement operation is cancelled and the movement operation is replaced by the copy operation, FIG. 22A illustrates an example of an image in a case where the operation executed after the object is moved is left as an operation executed after the object is duplicated, and FIG. 22B illustrates an example of the relevant operation history screen.

### DETAILED DESCRIPTION

Hereinafter, an exemplary embodiment of the present invention will be described with reference to the accompanying drawings.

### First Exemplary Embodiment

System Configuration

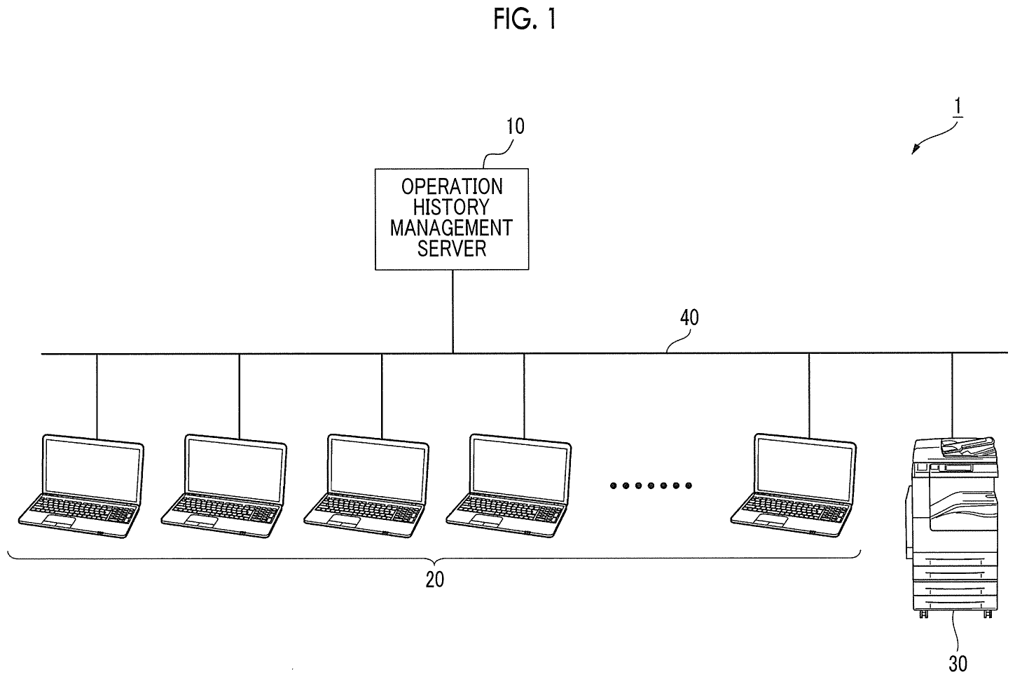

FIG. 1 is a diagram illustrating an example of a configuration of a work management system 1 according to a first exemplary embodiment.

The work management system 1 according to the first exemplary embodiment has a configuration in which an operation history management server 10 which manages a history of an operation with respect to an object, a terminal 20 which is operated by a worker (who includes a manager), and an image forming apparatus 30 which has a printing function, a copy function, a scanning function, and a FAX function, are connected to a network 40.

Here, the terminal 20 includes, for example, a desktop computer, a notebook-type computer, a smart phone, and a wearable terminal.

The network 40 includes, for example, a local network or the Internet.

The work management system 1 is an example of an information processing system.

In a case of the exemplary embodiment, the object refers to data that is a target of an operation which is executed by the worker.

In the exemplary embodiment, the object is used as a meaning of a single object or a meaning of an assembly of a plurality of objects.

The object includes, for example, a data file, a data folder (container), data treated in a document management system, data (for example, data of a work distribution chart) treated in a system which manages a project or a work process, management data in which the data file is associated with each procedure of the work process, a figure, an image (which includes character data), a photograph, a text (a text, a symbol, or the like), a text box, a work area (window) of an application.

Operation History Management Server

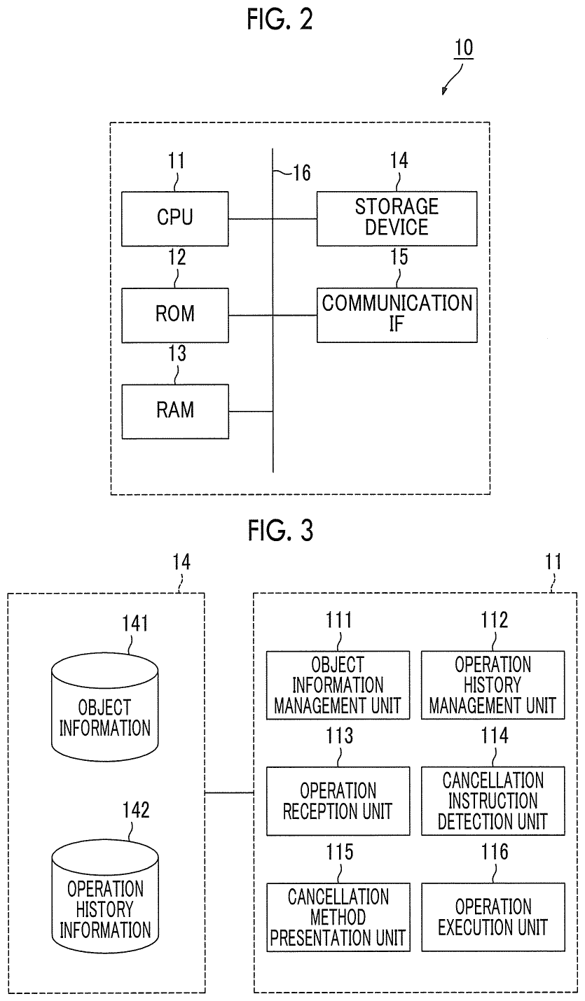

FIG. 2 is a diagram illustrating an example of a configuration of hardware of an operation history management server 10 according to the first exemplary embodiment.

The operation history management server 10 includes a Central Processing Unit (CPU) 11 which controls a whole apparatus by executing a program (including basic software), a ROM 12 which stores a program, such as a Basic Input Output System (BIOS) or basic software, and a Random Access Memory (RAM) 13 which is used as a program execution area.

The CPU 11, the ROM 12, and the RAM 13 are included in a so-called computer, and execute various types of information processing. Meanwhile, the ROM 12 includes a non-volatile semiconductor memory.

A storage device 14 includes, for example, a hard disk device, and stores an application program which manages the history of the operation with respect to the object, information of the object, information of the history of the operation, and the like.

The communication interface (communication IF) 15 is used for connection to the network 40.

The storage device 14 may be an external storage device (network storage). In addition, the storage device 14 may be an on-premises type or a cloud type.

Here, the operation history management server 10 is an example of an information processing apparatus. Meanwhile, the operation history management server 10, which uses the external storage device, is an example of the information processing system.

FIG. 3 is a diagram illustrating an example of a functional configuration of the operation history management server 10 according to the first exemplary embodiment.

The operation history management server 10, which is viewed from a functional aspect, functions as an object information management unit 111 which manages object information 141 preserved in the storage device 14, an operation history management unit 112 which manages operation history information 142 preserved in the storage device 14, an operation reception unit 113 which receives the operation with respect to the object, a cancellation instruction detection unit 114 which detects an instruction to cancel the operation, a cancellation method presentation unit 115 which presents an operation cancellation method to a user, and an operation execution unit 116 which executes an operation instructed by the user.

The functions are realized through execution of an application program by the CPU 11.

The object information 141 is information relevant to the object, and also includes data on a side in which the object is managed. The object information 141 differs depending on a type of the object. The object information 141 also includes, for example, the object, an attribute of the object, and a relation between objects (for example, a disposition, an arrangement, a hierarchy, and link information). Here, the relation between the objects also includes information used to specify a location on a file system.

The operation history information 142 is the history of the operation which is executed in the past, and an executed order is also recorded therein. Content of the operation differs depending on the type of the object. The operation includes, for example, new preparation, updating, move, copy (duplication), edit, input, removal (clear), and the like.

The object information management unit 111 provides a function of managing a current situation of the object through the object information 141.

The operation history management unit 112 provides a function of preserving the executed operation as the operation history information 142 in the storage device 14.

The operation reception unit 113 provides a function of receiving the operation, which is executed by the user, with respect to a specific object through the terminal 20 (see FIG. 1).

The cancellation instruction detection unit 114 provides a function of detecting an instruction to cancel the operation which is executed by the user. In the case of the exemplary embodiment, the cancellation instruction detection unit 114 sets cancellation of a movement operation as a detection target.

The cancellation method presentation unit 115 provides a function of presenting a process, which is selectable or executable in a case where the operation is cancelled, to the user.

In the case of the exemplary embodiment, for example, the cancellation method presentation unit 115 presents whether to cancel operations, which are executed after the movement operation that is a cancellation target, collectively (together) or leave the operation which is executed after the movement operation that is the cancellation target by cancelling only the movement operation.

In addition, the cancellation method presentation unit 115 presents whether or not to change the movement operation in the history of the operation of the object to a copy (duplication) operation.

Selection of the cancellation method is received by the operation reception unit 113.

The operation execution unit 116 provides a function of executing the operation (including an instruction) which is received by the operation reception unit 113.

Example of Operation

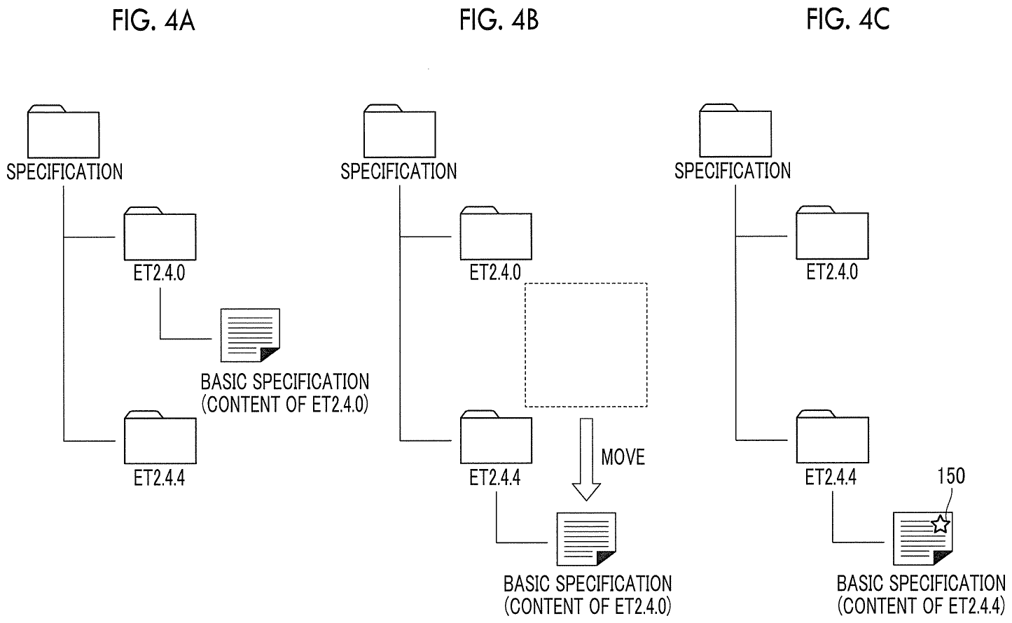

FIGS. 4A to 4C are diagrams illustrating the movement operation, which is the cancellation target, and another subsequent operation. FIG. 4A illustrates a location of a data file acquired before the movement operation, FIG. 4B illustrates a location of the data file acquired after the movement operation, and FIG. 4C illustrates a state in which editing is added to the data file acquired after the movement operation.

The data file is an example of the object.

In FIGS. 4A to 4C, the cancellation of the movement operation between data folders of data files is assumed.

In cases of FIGS. 4A to 4C, a name, such as a basic specification, is attached to a data file which is the target of the movement operation.

The data file (basic specification) acquired before the movement operation is located in a folder “ET2.4.0” which is in a lower hierarchy of a folder “specification”.

In a case of FIG. 4A, the data file (basic specification) is moved to another folder “ET2.4.4” which is in the lower hierarchy of the folder “specification” through the movement operation which is executed by the user.

In the movement operation, content of the data file (basic specification) is the same before and after the movement is performed. Therefore, in FIG. 4B, “content of ET2.4.0” is written as description of the data file (basic specification) located in the folder “ET2.4.4”.

In a case of FIG. 4C, an editing operation is executed on the data file (basic specification) acquired after the movement operation, and the content is changed immediately after the movement.

Here, in FIG. 4C, a difference in content is expressed using an asterisk 150 in the drawing. In addition, “content of ET2.4.4” is written as the description of the data file (basic specification) acquired after the editing operation is executed.

Example of Operation Screen

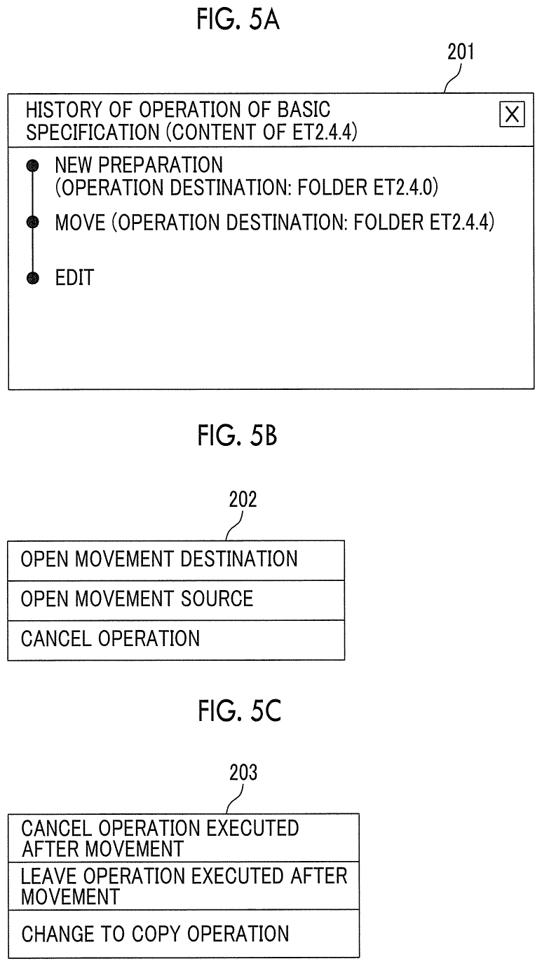

FIGS. 5A to 5C are diagrams illustrating examples of operation screens prepared for the basic specification. FIG. 5A illustrates an example of an operation screen 201 used to display the history of the operation, FIG. 5B illustrates an example of an operation screen 202 used to display options with respect to the movement operation, and FIG. 5C illustrates an example of an operation screen 203 used to display options in a case where the operation is cancelled.

The operation screen 201 is displayed, for example, by selecting the data file (basic specification) of the folder “ET2.4.4” on the screen illustrated in FIG. 4C and clicking a right button of a mouse.

In a case of FIG. 5A, a history of a series of operations corresponding to FIGS. 4A to 4C is shown in an order of execution on the operation screen 201. In the example of FIG. 5A, the older an execution time point is, the higher an operation is displayed.

Base on the history of the operation, it is understood that the basic specification is newly prepared in the folder “ET2.4.0”, the basic specification is moved to the folder “ET2.4.4”, and, thereafter, the editing operation is executed.

For example, the operation screen 202 is displayed in a case where a mouse cursor is moved to a location of “move” of the history of the operation displayed on the operation screen 201.

In a case of FIG. 5B, three operations, that is, “open movement destination”, “open movement source”, and “cancel operation” are displayed as selectable operations on the operation screen 202.

In a case where an operation “open movement destination” is selected in the exemplary embodiment, another screen which shows content of the folder “ET2.4.4 is displayed.

In addition, in a case where an operation “open movement source” is selected, another screen which shows content of the folder “ET2.4.0 is displayed.

In addition, in a case where an operation “cancel operation” is selected, the operation screen 203 is displayed.

In a case of FIG. 5C, operations “cancel operation executed after movement”, “leave operation executed after movement”, and “change to copy operation” are displayed as operations, which are selectable in a case where the movement operation is cancelled, on the operation screen 203.

Here, the operation “cancel operation executed after movement” means that the whole operations (here, the editing operation), which are executed after the movement operation, are also removed.

The operation “leave operation executed after movement” means that the whole operations (here, the editing operation), which are executed after the movement operation, are left. In a case where the operation is executed, the data file acquired before the movement operation is restored in a movement source folder while the data file, in which content acquired after the editing is performed is preserved, is left in the current folder. That is, a state, in which a plurality of data files having the same file name coexist indifferent folders, is made.

The operation “change to copy operation” means that the whole operations (here, the editing operation), which are executed after the movement operation, are left and that the movement operation of the history of the operation is rewritten to the copy operation. Here, in a case where the operation is performed, the data file acquired before the movement operation is restored in the movement source folder while the data file, in which content acquired after the editing is performed is preserved, is left in a current folder.

Meanwhile, in a case where the operation is selected, it is not possible to check a fact that the movement operation is executed from the history of the operation of the data file (basic specification) located in the folder “ET2.4.4”.

Example of Execution of Processing Operation

Hereinafter, a detailed example of the operation will be described for the case where the movement operation is cancelled.

Case Where Operation Executed After Movement is Cancelled

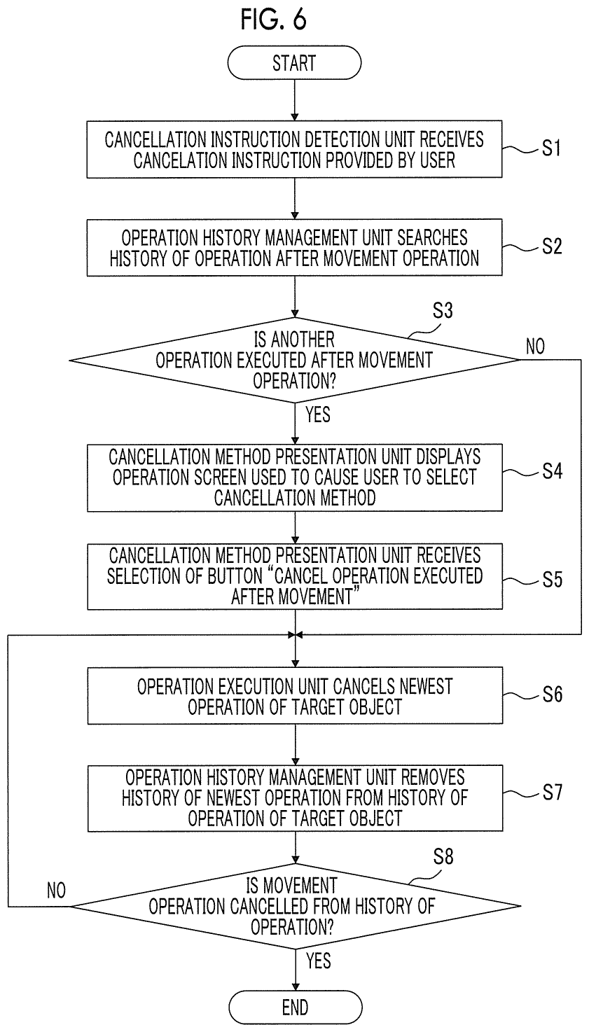

Here, an example of a processing operation will be described with reference to FIGS. 6 to 8C.

FIG. 6 is a flowchart illustrating the example of the processing operation in a case where the operation executed after the movement is cancelled.

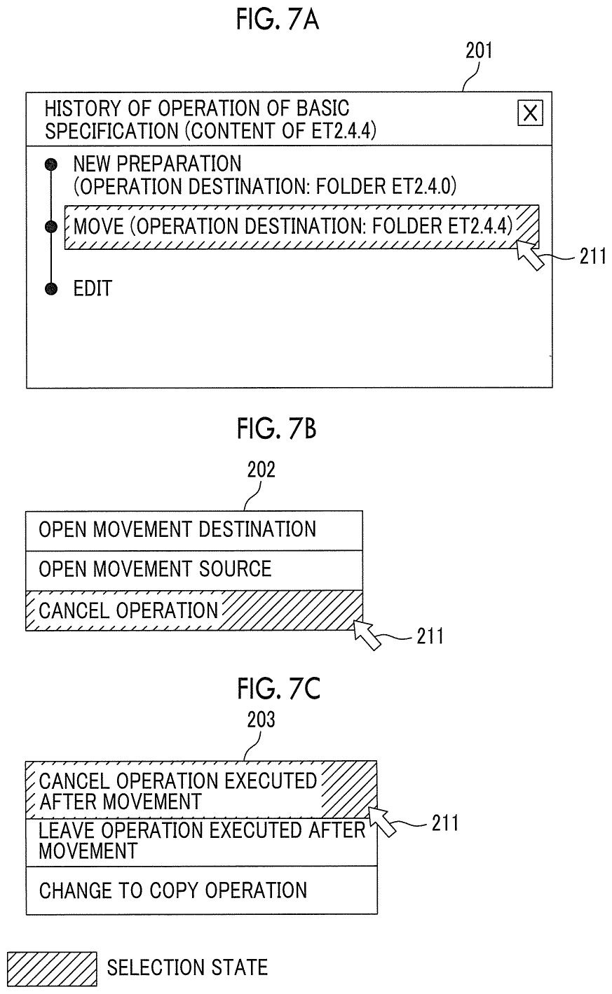

FIGS. 7A to 7C are diagrams illustrating examples of the operation screens prepared for the basic specification. FIG. 7A illustrates a state in which the movement operation is selected on the operation screen 201, FIG. 7B illustrates a state in which the cancellation of the operation is selected on the operation screen 202, and FIG. 7C illustrates a state in which the button “cancel operation executed after movement” is selected on the operation screen 203.

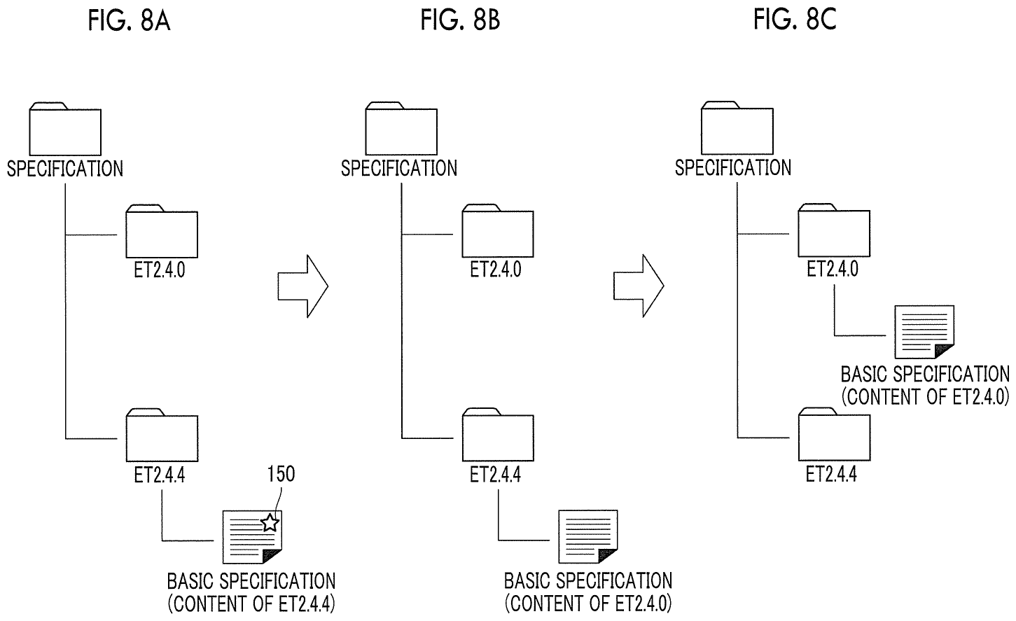

FIGS. 8A to 8C are diagrams illustrating locations and states of the basic specification acquired before and after the movement operation is cancelled. FIG. 8A illustrates a display state acquired before the movement operation is cancelled, FIG. 8B illustrates a transitional state (not illustrated in the drawing) while the movement operation is cancelled, and FIG. 8C illustrates a display state acquired after the movement operation is cancelled.

The flowchart illustrated in FIG. 6 starts from a state in which the operation screen 202 (see FIG. 7B) corresponding to the movement operation is displayed. In FIG. 6, each of the steps is indicated by a symbol S.

The operation screen 202 is displayed in a case where “move” on the operation screen 201 (see FIG. 7A) is selected using a mouse cursor 211 (see FIGS. 7A to 7C).

In the state, the user clicks a button “cancel operation” on the operation screen 202 using the mouse cursor 211. The click operation is received by the cancellation instruction detection unit 114 (see FIG. 3) as a cancellation instruction by the user (step S1).

In a case where the cancellation instruction of the user is received, the operation history management unit 112 (see FIG. 3) searches the history of the operation executed after the movement operation (step S2).

The operation history management unit 112 searches for an operation, which is executed after the movement operation designated by the user as the cancellation target, by targeting the operation history information 142 (see FIG. 3).

The operation history management unit 112 determines whether or not another operation is executed after the movement operation using a result of the search (step S3).

In a case where a positive result is acquired in step S3, the cancellation method presentation unit 115 (see FIG. 3) displays the operation screen 203 (see FIG. 7C) used to cause the user to select the cancellation method (step S4).

The user selects an operation desired to be executed among the options displayed on the operation screen 203.

Here, the cancellation method presentation unit 115 receives selection of the button “cancel operation executed after movement” (step S5).

After step S5 is performed or a negative result is acquired in step S3, the operation execution unit 116 (see FIG. 3) cancels a newest operation of a target object (step S6).

Even in a case where a plurality of operations, which are executed after the movement, exist, the cancellation target is only the newest operation among the plurality of operations. That is, only one operation is cancelled.

In the examples of FIGS. 8A to 8C, a state in which the editing operation is cancelled is expressed by removing the asterisk 150. In a case of FIG. 8B, content of the basic specification which exists in the folder “ET2.4.4” is returned to content in the folder “ET2.4.0” through the cancellation of the editing operation.

Subsequently, the operation history management unit 112 removes the history of the newest operation from the history of the operation of the target object (step S7).

Even in a case where a history of a plurality of operations executed after the movement exists, the cancellation target is only the history of the newest operation among the operations. That is, a history of only one operation is cancelled.

Thereafter, the operation history management unit 112 determines whether or not the movement operation is cancelled from the history of the operation (step S8).

While a negative result is acquired in step S8, the cancellation of the operation executed by the operation execution unit 116 and the removal of the history of the operation executed by the operation history management unit 112 are repeated.

After all, in a case where the history of the operation corresponding to the movement operation which is the cancellation target is cancelled, a positive result is acquired in step S8, and a series of processes end.

As a result, the state illustrated in FIG. 8C is restored.

That is, a state, in which a result of the operation executed after the movement is not included, is restored.

Although the state, which is acquired after the operation is executed, is the same as the result of the prior cancellation operation, an opportunity of selecting whether or not to cancel another operation executed after the operation, which is the cancellation target, is given to the user.

In a case where the opportunity of selection is given, the state acquired after the cancellation becomes a state desired for the user, and an efficiency of a job of the user is improved.

Case Where Operation Executed After Movement is Left

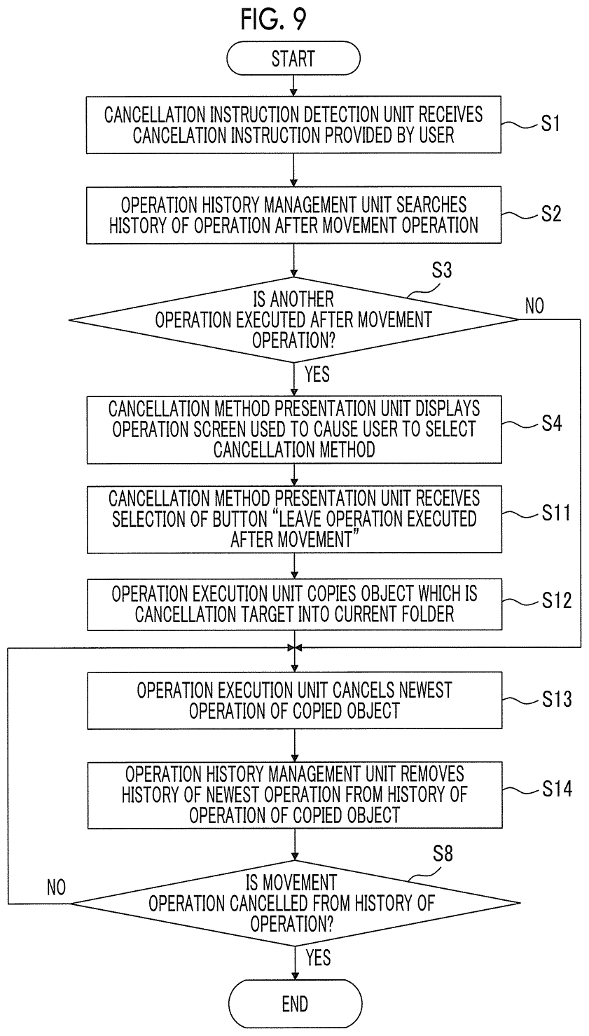

Here, an example of the processing operation will be described with reference to FIGS. 9 to 14.

FIG. 9 is a flowchart illustrating the example of the processing operation in a case where the operation executed after the movement is left. In FIG. 9, the same reference symbols are attached to parts which are relevant to FIG. 6.

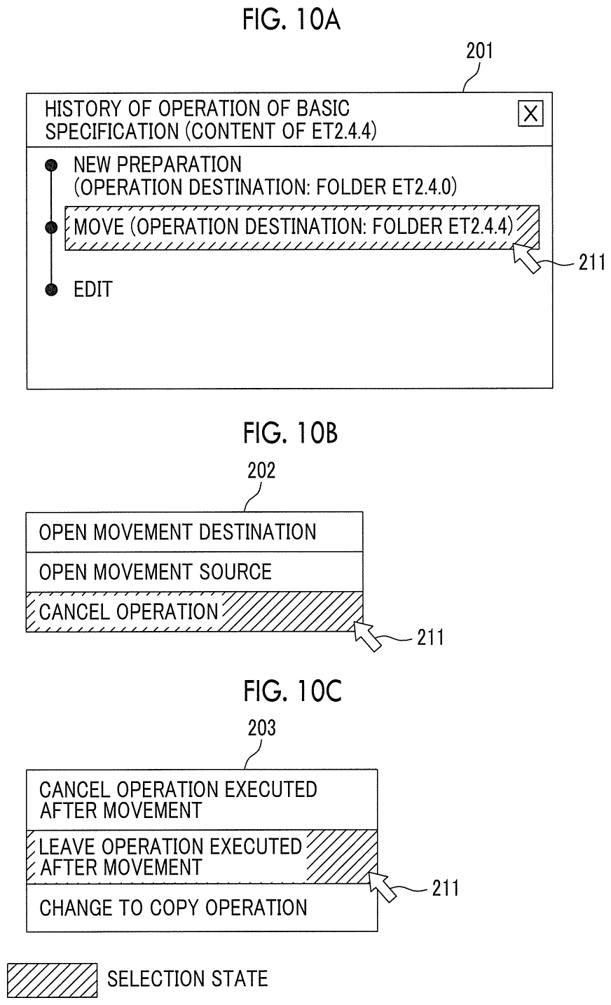

FIGS. 10A to 10C are diagrams illustrating examples of the operation screens prepared for the basic specification. FIG. 10A illustrates a state in which the movement operation is selected on the operation screen 201, FIG. 10B illustrates a state in which the cancellation of the operation is selected on the operation screen 202, and FIG. 10C illustrates a state in which a button “leave operation executed after the movement is performed” is selected on the operation screen 203.

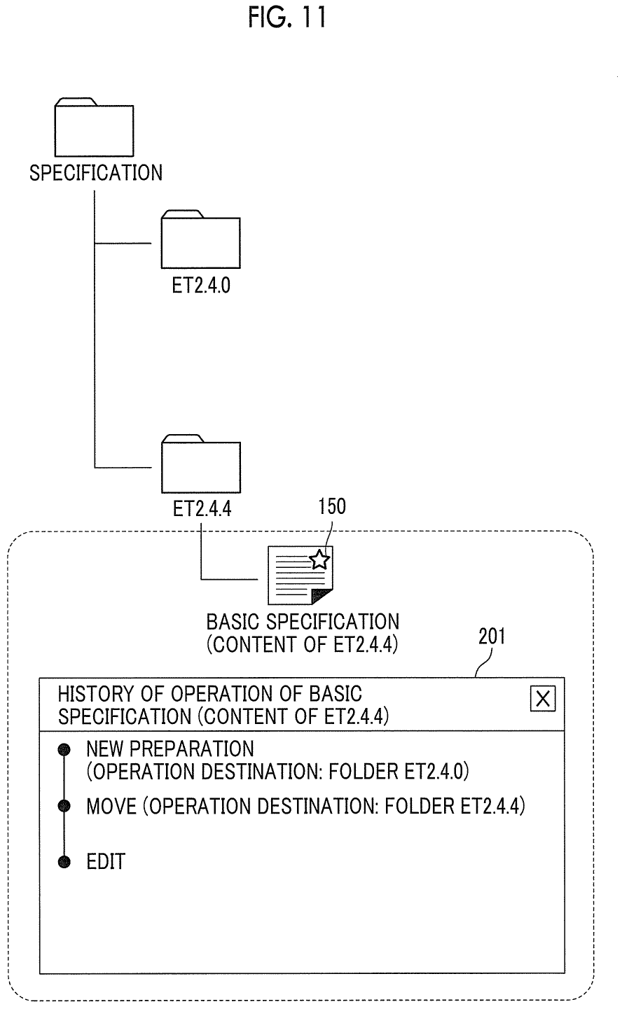

FIG. 11 is a diagram illustrating a state of the basic specification acquired before the movement operation is cancelled.

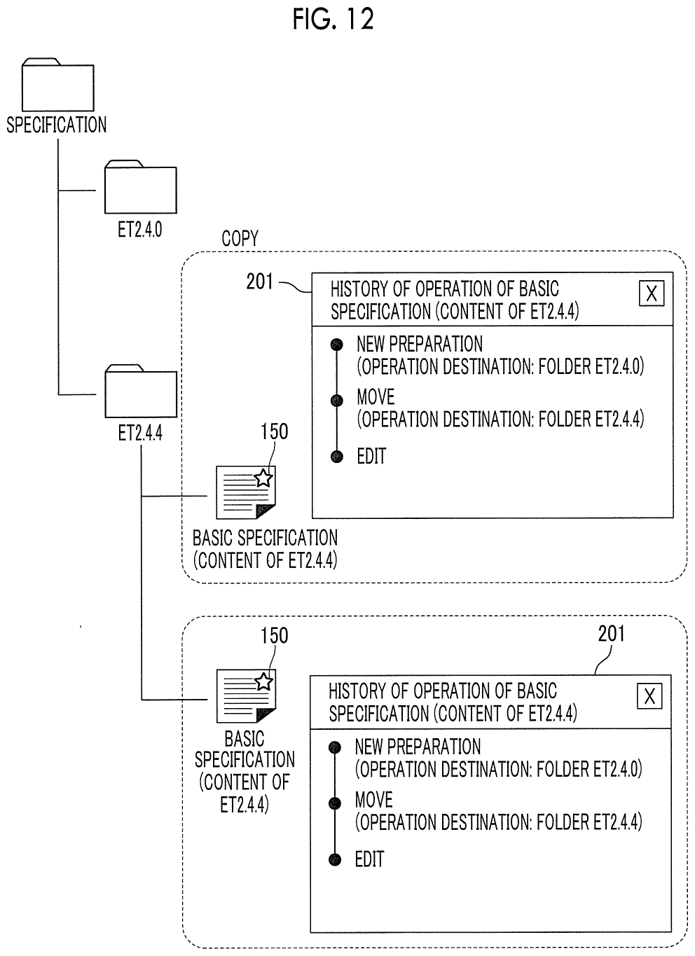

FIG. 12 is a diagram illustrating a first transitional state acquired while the movement operation is cancelled.

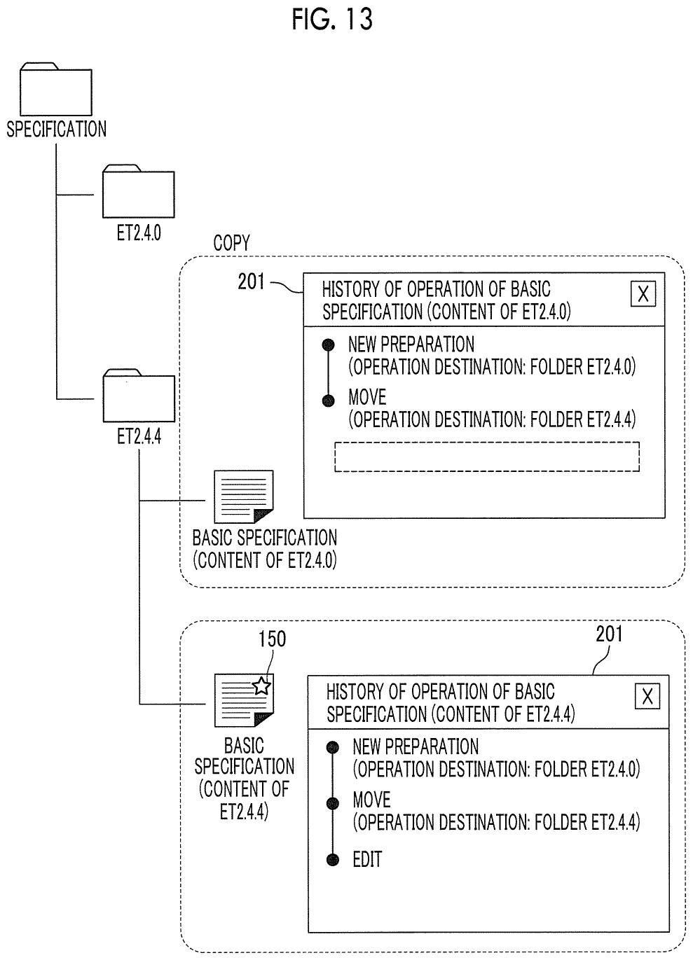

FIG. 13 is a diagram illustrating a second transitional state acquired while the movement operation is cancelled.

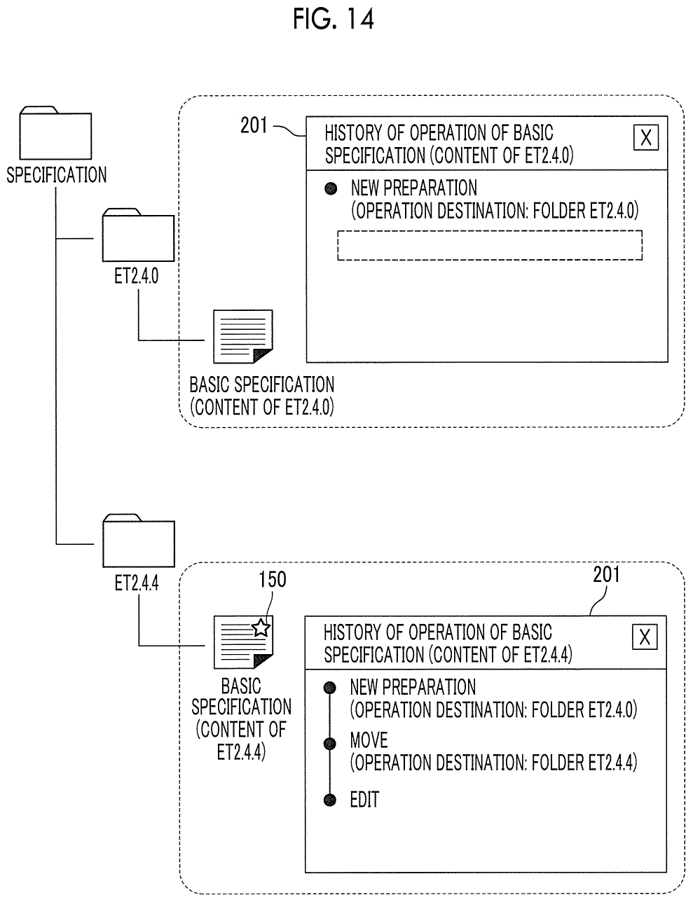

FIG. 14 is a diagram illustrating a state of the basic specification acquired after the movement operation is cancelled.

FIGS. 11 to 14 are diagrams prepared for the description.

The flowchart illustrated in FIG. 9 starts from a state in which the operation screen 202 (see FIG. 10B) corresponding to the movement operation is displayed. In a case of FIG. 9, each of the steps is indicated by a symbol S.

Processes in steps 1 to 4 of the flowchart illustrated in FIG. 9 are the same as in the flowchart illustrated in FIG. 6.

Hereinafter, a process performed after the operation screen 203 (see FIG. 10) is displayed will be described.

Here, the cancellation method presentation unit 115 receives selection of the button “leave operation executed after movement” (step S11).

After step S11, the operation execution unit 116 (see FIG. 3) copies an object which is the cancellation target into the current folder (step S12).

Here, the object is the data file (basic specification) located in the folder “ET2.4.4”.

As illustrated in FIG. 11, the editing operation is added to the data file (basic specification) after the movement into the folder “ET2.4.4”, and thus the asterisk 150 indicative of existence of editing is attached in FIG. 11.

FIG. 12 illustrates the transitional state at a point of time in which step S12 is executed. Since the state is the transitional state, the state illustrated in FIG. 12 is not displayed on the job screen of the terminal 20 (see FIG. 1). That is, content of FIG. 12 is used to describe a state of the history of the operation of the data file (basic specification) which is the target of the operation.

As illustrated in FIG. 12, in the folder “ET2.4.4”, two data files (basic specifications) having the same content are transitionally disposed.

After step S12 is executed or after the negative result is acquired in step S3, the operation execution unit 116 (see FIG. 3) cancels the newest operation of the copied object (step S13).

Even in a case where a plurality of operations executed after the movement exist, the cancellation target is only the newest operation among the operations. That is, only one operation is cancelled.

In the example of FIG. 13, the state in which the editing operation is cancelled is expressed by removing the asterisk 150. In addition, the content of the copied basic specification returns to “content of ET2.4.0”.

Subsequently, the operation history management unit 112 removes the history of the newest operation from the history of the operation of the copied object (step S14).

Even in a case where the history of the plurality of operations executed after the movement exists, the cancellation target is only the history of the newest operation among the operations. That is, the history of only one operation is cancelled.

In the example of FIG. 13, “edit” is cancelled from the history of the operation of the copied data file (basic specification). FIG. 13 illustrates existence of the history of the cancelled operation using a broken line.

Thereafter, the operation history management unit 112 determines whether or not the movement operation is cancelled from the history of the operation (step S8).

While a negative result is acquired in step S8, the cancellation of the operation by the operation execution unit 116 and removal of the history of the operation by the operation history management unit 112 are repeated.

In the case of the exemplary embodiment, the movement operation is cancelled due to the cancellation of a subsequent newest operation.

FIG. 14 illustrates a state acquired after the movement operation of the copied data file (basic specification) is cancelled.

As a result that the movement operation is cancelled, the copied data file (basic specification) returns to the movement source folder “ET2.4.0”, and only “new preparation” is left for the history of the operation.

As above, in a case where the history of the operation corresponding to the movement operation which is the cancellation target is cancelled, a positive result is acquired in step S8, and a series of processes end.

As a result, a state is acquired in which the data file (basic specification) acquired before the movement operation is executed exists in the folder “ET2.4.0” and the data file (basic specification), to which the content of the operation executed after the movement operation is executed is reflected, exists in the folder “ET2.4.4”.

The state is a state which does not appear in a previous method in which the operation executed after the movement operation is evenly removed.

In this case, the user is capable of restoring the data file (basic specification), which does not include the editing operation, into the movement source folder while leaving the data file (basic specification), which includes the editing operation, in the movement destination folder by cancelling the movement operation.

Therefore, the user is capable of reusing editing the content of the operation, which is executed after the movement operation, without change. That is, even in a case where it is desired to reuse the content of the editing, the process ends without repeating the same operation, and thus the efficiency of the job is improved.

Case Where History of Movement Operation is Changed to Copy Operation While Leaving Operation Executed After Movement

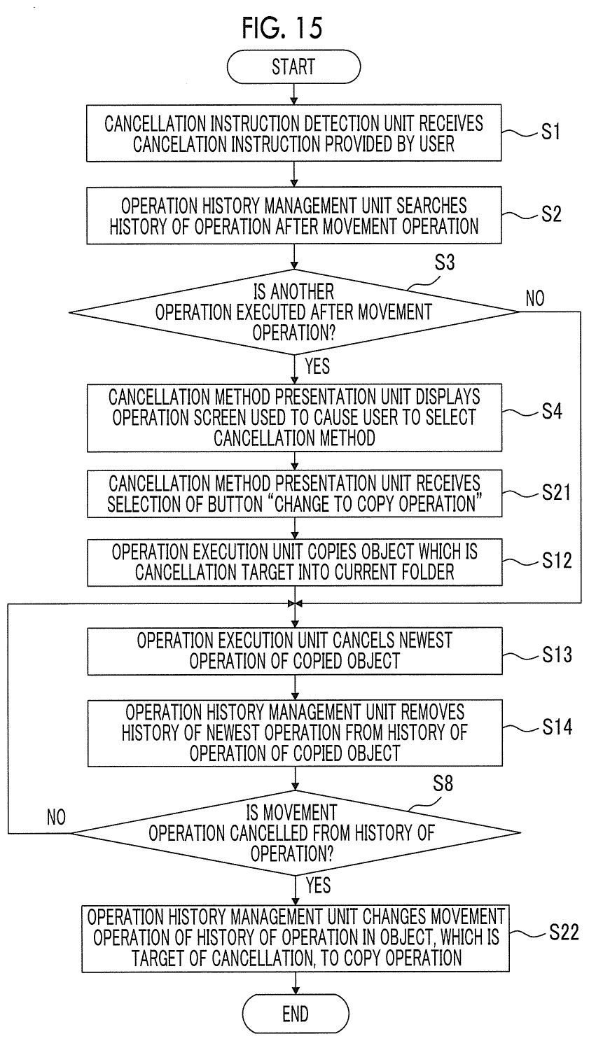

Here, an example of the processing operation will be described with reference to FIGS. 15 to 17.

FIG. 15 is a flowchart illustrating the example of the processing operation in case where the history of the movement operation is replaced by the copy operation while leaving the operation executed after the movement. In FIG. 15, the same reference symbols are attached to parts which are relevant to FIG. 9.

FIGS. 16A to 16C are diagrams illustrating examples of the operation screens prepared for the basic specification. FIG. 16A illustrates a state in which the movement operation is selected on the operation screen 201, FIG. 16B illustrates a state in which the cancellation of the operation is selected on the operation screen 202, and FIG. 16C illustrates a state in which a button “change movement operation by copy operation” is selected on the operation screen 203.

FIG. 17 is a diagram illustrating an example of the state of the basic specification acquired after the movement operation is cancelled.

The flowchart illustrated in FIG. 15 starts from a state in which the operation screen 202 (see FIG. 16B) corresponding to the movement operation is displayed. In a case of FIG. 15, each of the steps is also indicated by a symbol S.

The flowchart illustrated in FIG. 15 is the same as the flowchart illustrated in FIG. 9 other than steps 21 and 22.

Hereinafter, the different steps will be described.

Step S21 is executed instead of step S11 which is executed between step S4 and step S12.

In step S21, the cancellation method presentation unit 115 receives selection of the button “change to copy operation”.

The operation corresponds to an operation illustrated in FIG. 16C.

Step S22 is executed after the positive result is acquired in step S8.

As described above, a state in which the positive result is acquired in step S8 is illustrated in FIG. 14.

In the example of FIG. 14, in the history of the operation of the data file (basic specification) which exists in the folder “ET2.4.4”, “new preparation” to the folder “ET2.4.0”, subsequently, “move” to the folder “ET2.4.4”, and, subsequently, “edit” are described.

In step S22, a process of changing the “move” operation of the history of the operation to the “copy” operation is performed.

FIG. 17 illustrates a state after the history of the operation is rewritten.

In this case, a state is acquired in which the data file (basic specification) acquired before the movement operation is executed exists in the folder “ET2.4.0” and the data file (basic specification), to which the content of the operation executed after the movement operation is executed is reflected, exists in the folder “ET2.4.4”. The state is the same as in the case where the button “leave operation executed after movement” is selected.

Here, on the history of the operation, it is not possible to check a fact that the “move” operation is executed from the history of the operation of the data file (basic specification) in the folder “ET2.4.4”.

The state is also a state which does not appear in the previous method in which the operation executed after the movement operation is evenly removed.

In this case, the user is capable of restoring the data file (basic specification), which does not include the editing operation, in the movement source folder while leaving the data file (basic specification), which includes the editing operation, in the movement destination folder by cancelling the movement operation.

Therefore, the user ends the operation which is executed after the movement operation without waste. That is, even in a case where it is desired to reuse the content of editing the process ends without repeating the same operation, and thus the efficiency of the job is improved.

### Another Exemplary Embodiment

Hereinabove, the exemplary embodiment of the present invention is described. However, a technical scope of the present invention is not limited to the scope described in the above exemplary embodiment.

With respect to the above-described exemplary embodiment, it is apparent that various changes or improved forms are included in the technical scope of the present invention from the description of claims.

### Another Exemplary Embodiment 1

In the above-described exemplary embodiment, the operation history management server 10 is provided with a function of presenting the operation screen 203 for reception of treatment of the operation executed after the movement operation in a case where the movement operation is cancelled. However, the function may be executed as a function of the terminal 20. Here, the terminal 20 as the computer provides the above-described function through execution of the program. Here, the terminal 20 is an example of an information processing apparatus.

### Another Exemplary Embodiment 2

In the above-described exemplary embodiment, a case is described where the function of presenting the operation screen 203 for reception of the treatment of the operation executed after the movement operation in a case where the movement operation is cancelled through the computer included in the work management system 1 is provided. However, the function is not limited to the use in the computer used for a specific purpose.

### Another Exemplary Embodiment 3

In the above-described exemplary embodiment, for example, three types of operations are illustrated as the options used in the case where the movement operation is cancelled as illustrated in FIG. 5C. However, two selection targets, that is, “cancel operation executed after movement” and “leave operation executed after the movement or “cancel operation executed after movement” and “change to copy operation” may be provided.

### Another Exemplary Embodiment 4

In the above-described exemplary embodiment, an example in which only one movement operation is included in the history of the operation is described. However, a plurality of movement operations may be included. Even in the case, the cancellation target is one among the plurality of movement operations.

### Another Exemplary Embodiment 5

In the above-described exemplary embodiment, a case where movement between data file folders is cancelled is described. However, it is possible to use the exemplary embodiment in the cancellation of movement of a location of a text string, a figure, a photograph, an image, or the like on a display.

FIGS. 18A to 18C are diagrams illustrating the cancellation of the operation of moving the location on the display. FIG. 18A illustrates an example of an image 301 in which FIGS. 311 and 312 are disposed, FIG. 18B illustrates an example of an operation history screen 321 displayed in a case where a cancellation button is operated, and FIG. 18C illustrates an example of an operation screen 331 used to display options in a case where the operation is cancelled.

In cases of FIGS. 18A to 18C, the FIG. 311 is a square and the FIG. 312 has a circular shape.

On the operation history screen 321 which is displayed for the cancellation of the operation, an operation located at a top of the history of the operation is “input object” and an operation which is located at the end of the history of the operation is “filling effect”. The operation history screen 321 illustrated in FIG. 18B includes “move object” and “change object size”.

The operation screen 331 is displayed in a case where the “move object” is selected as the cancellation target. The options displayed on the operation screen 331 are the same as in the above-described exemplary embodiment. That is, “cancel operation executed after movement”, “leave operation executed after movement” and “change to copy operation” are presented as three options.

FIG. 19 is a diagram illustrating a change on a display corresponding to an operation which appears on the image 301. (A) of FIG. 19 illustrates a disposition acquired before an object is moved, (B) of FIG. 19 illustrates a disposition acquired after the object is moved, (C) of FIG. 19 illustrates a state acquired after a size of the object is changed, and (D) of FIG. 19 illustrates a state in which the filling effect is added to the object.

In FIG. 19, the FIG. 312 having the circular shape is the movement target and is deformed into an elliptical shape after the location on the display is moved, and, furthermore, the filling effect is added.

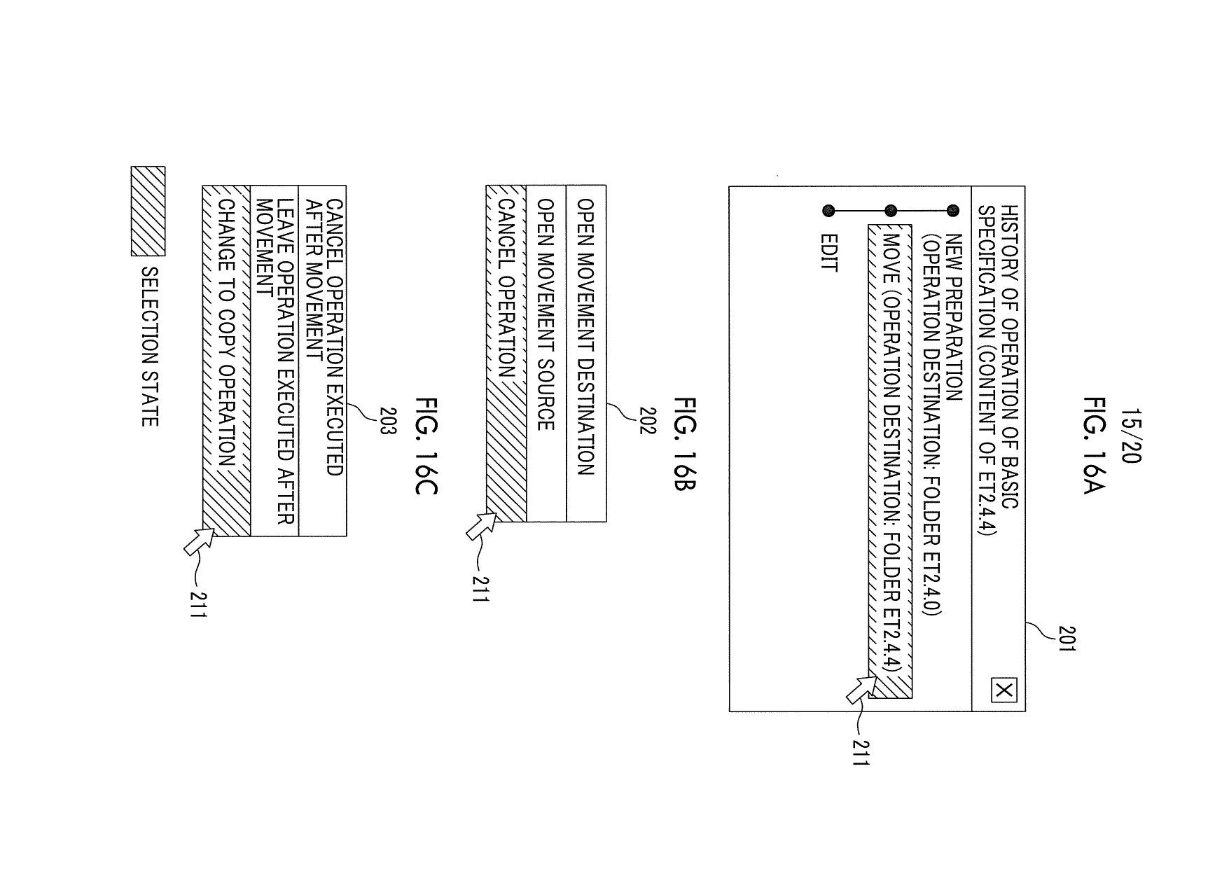

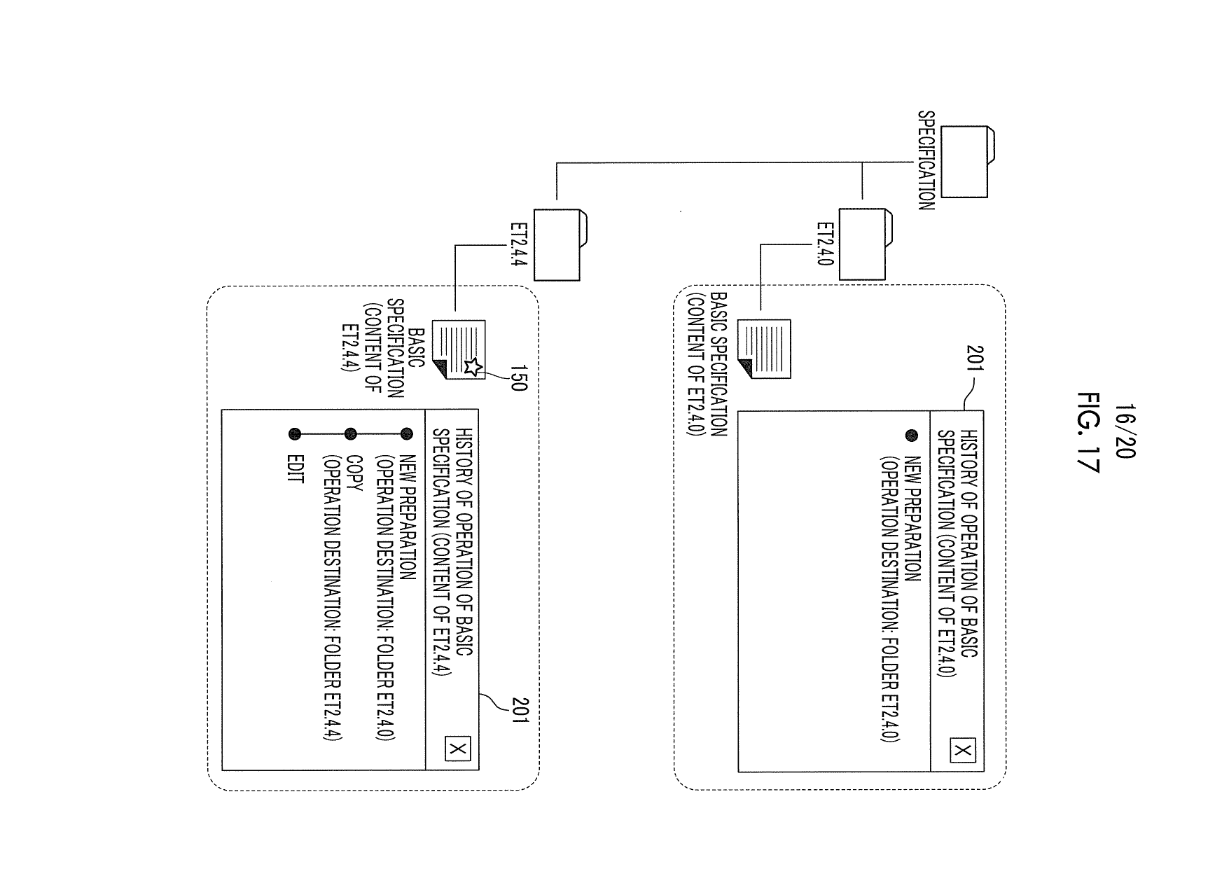

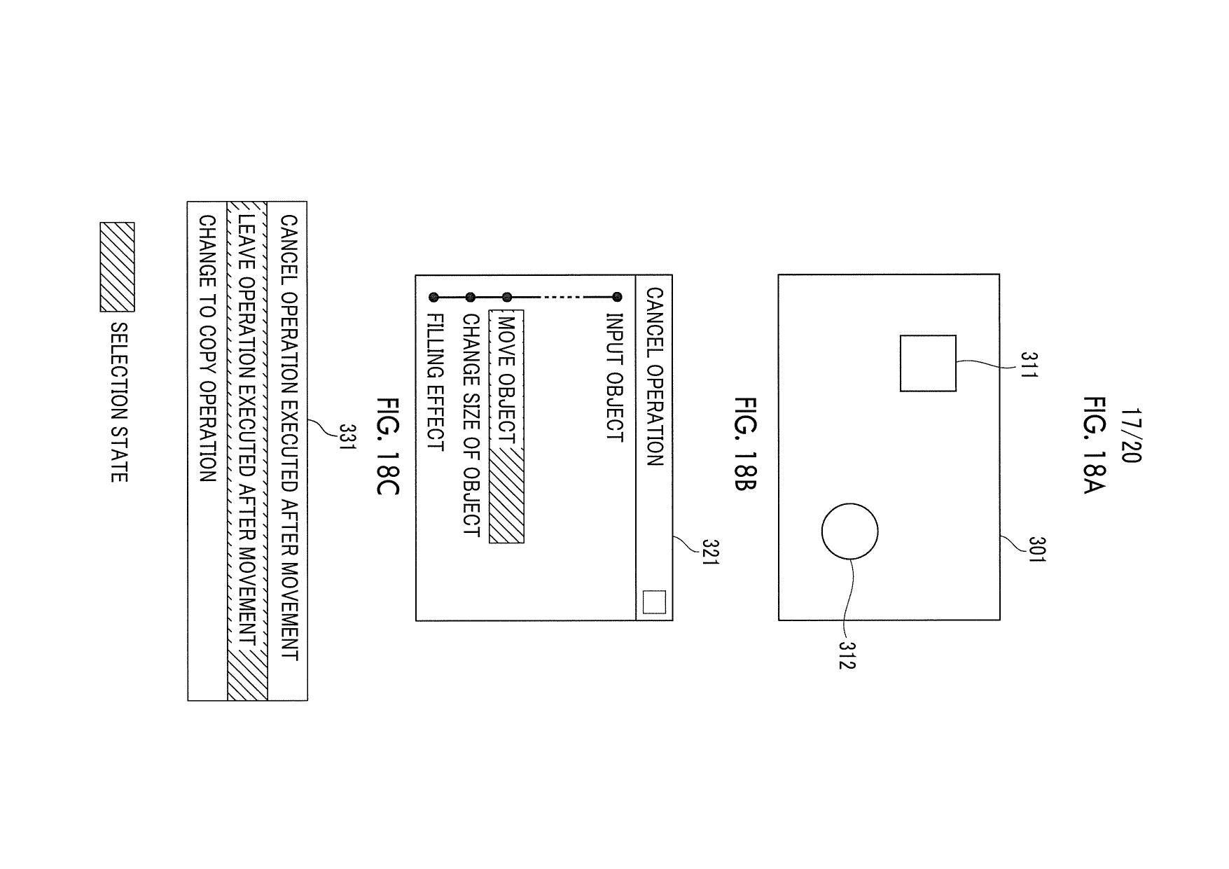

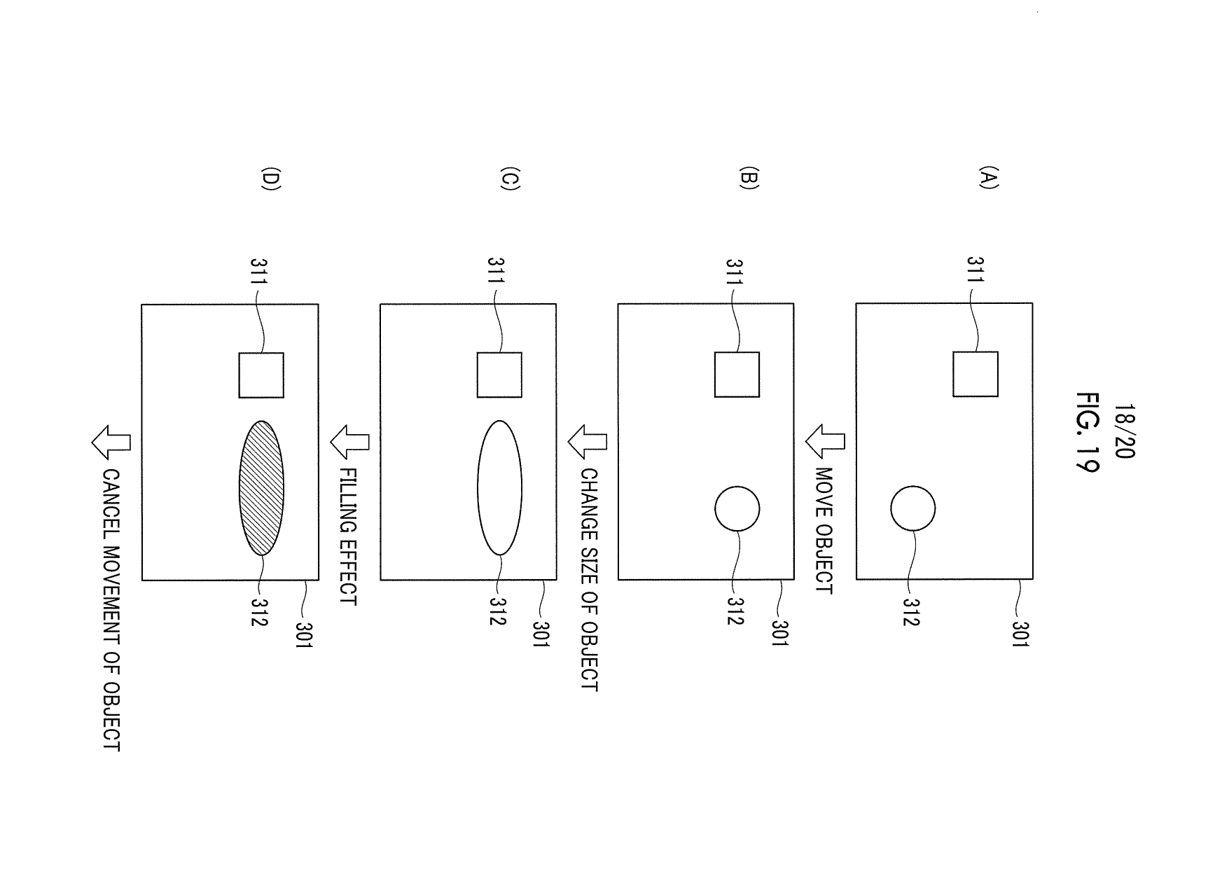

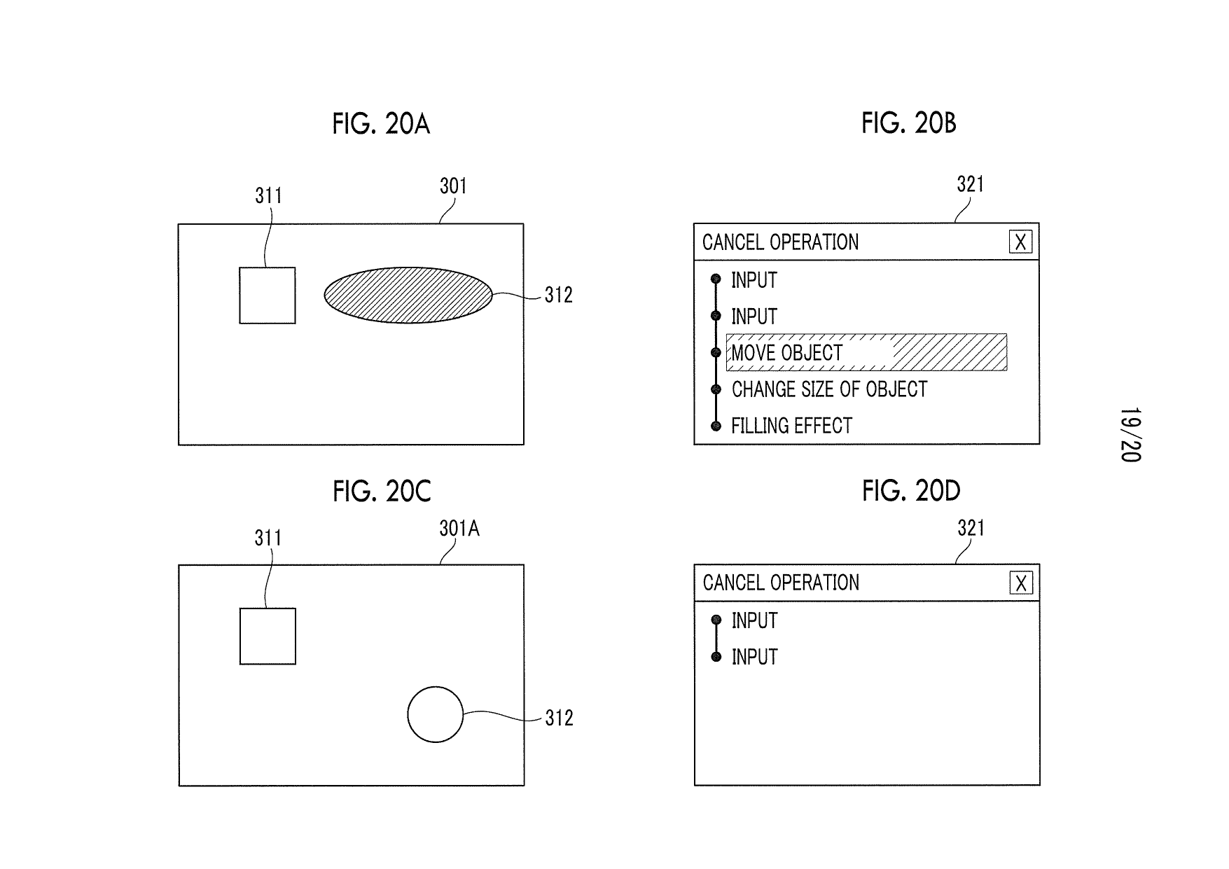

FIGS. 20A to 20D are diagrams illustrating examples of the image 301 in which the operation executed after the object is moved is left and an image 301A in which the operation executed after the object is moved is removed. FIGS. 20A and 20B illustrate examples of the operation history screen 321 corresponding to the image 301 in which the operation executed after the object is moved is left, and FIGS. 20C and 20D illustrate examples of the operation history screen 321 corresponding to the image 301A in which the operation executed after the object is moved is removed.

The image 301 illustrated in FIG. 20A and the operation history screen 321 illustrated in FIG. 20B correspond to the operation screen 201 corresponding to the basic specification in the folder “ET2.4.4” illustrated in FIG. 14.

In contrast, the image 301A illustrated in FIG. 20C and the operation history screen 321 illustrated in FIG. 20D correspond to the operation screen 201 corresponding to the basic specification in the folder “ET2.4.0” illustrated in FIG. 14.

In a case of the exemplary example, the data file corresponding to the image 301A illustrated in FIG. 20C and the data file corresponding to the image 301 illustrated in FIG. 20A are prepared in the same folder using different names.

After all, the data file corresponding to the image 301A may be prepared in a folder which is different from that of the data file corresponding to the image 301. For example, the data file corresponding to the image 301A may be prepared in a temporary folder.

As described above, even in the operation “move object” is cancelled, the user is capable of preserving results of the operation “change object size” executed after the movement and the operation “filling effect”, and thus it is possible to omit repetition of the operation.

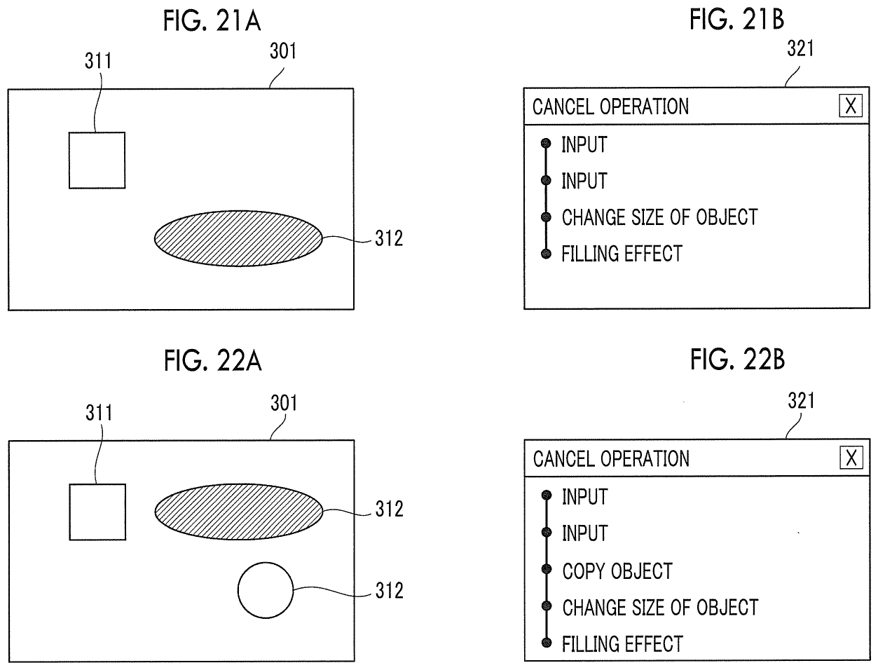

FIGS. 21A and 21B are diagrams illustrating examples of another image in a case where the operation executed after the object is moved is left. FIG. 21A illustrates an example of the image 301 in the case where the operation executed after the object is moved is left, and FIG. 21B illustrates an example of the relevant operation history screen 321.

In the examples illustrated in FIGS. 21A and 21B, only the operation “move object” is removed from the history of the operation. Therefore, effects of the operation “change object size” and the operation “filling effect” are not changed, and only the display location of the FIG. 312 returns to a location acquired before the movement.

In this case, the user is capable of continuing a job for another operation executed after the movement of the object without change.

FIG. 22A and 22B are diagrams illustrating an example of another image in a case where the object movement operation is cancelled and the movement operation is replaced by the copy operation. FIG. 22A illustrates an example of the image 301 in a case where the operation executed after the object is moved is left as an operation executed after the object is duplicated, and FIG. 22B illustrates an example of the relevant operation history screen 321.

In the examples illustrated in FIGS. 22A and 22B, the operation “move object” in the history of the operation is changed to an operation “copy object”. Therefore, in the same screen, FIG. 312 having the circular shape and the FIG. 312 having the elliptical shape is left.

Here, the user is capable of continuing a job for another operation executed after the movement of the object without input again.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a presentation section that, in a case where cancellation of a movement operation with respect to an object is received and another operation which is executed after the movement operation corresponding to a cancellation target exists, presents a screen used to receive treatment of the other operation.

2. The information processing apparatus according to claim 1,
wherein the screen includes options, which are used to determine whether or not to leave an object that preserves a result of the other operation, in a case where the movement operation is cancelled.

3. The information processing apparatus according to claim 2,
wherein the option, which is used to leave the object that preserves the result of the other operation, includes an option, which is used to replace the movement operation corresponding to the cancellation target by a duplication operation, on a history of an operation relevant to the object that preserves the result of the other operation.

4. The information processing apparatus according to claim 1,
wherein, in a case where the cancellation of the movement operation in which the result of the other operation is preserved is executed, duplication of the object that preserves the result of the other operation is generated before the cancellation is executed.

5. The information processing apparatus according to claim 4,
wherein the duplication of the object that preserves the result of the other operation is generated in a management location where an object corresponding to a duplication source exists at a point of time in which the movement operation is cancelled.

6. A non-transitory computer readable medium storing a program causing a computer to function as:
a presentation section that, in a case where cancellation of a movement operation with respect to an object is received and another operation which is executed after the movement operation corresponding to a cancellation target exists, presents a screen used to receive treatment of the other operation.

7. An information processing apparatus comprising:
presentation means for, in a case where cancellation of a movement operation with respect to an object is received and another operation which is executed after the movement operation corresponding to a cancellation target exists, presenting a screen used to receive treatment of the other operation.
